(19) United States
(12) Patent Application Publication
(10) Pub. No.: US 2011/0101671 A1
(43) Pub. Date: May 5, 2011

(54) UNIVERSAL SLIP AND EXPAND FITTING AND METHOD OF USING THE SAME

(76) Inventor: Harry Frederick Dixon, Durham, NC (US)

(21) Appl. No.: 12/765,696

(22) Filed: Apr. 22, 2010

Related U.S. Application Data
(60) Provisional application No. 61/171,808, filed on Apr. 22, 2009.

(51) Int. Cl. F16L 55/18

(52) U.S. Cl. 285/15

(57) ABSTRACT

The present invention relates to a method and apparatus for repairing water and sewer lines. The apparatus is a universal slip and expand fitting which will permanently or semi-permanently repair leaks in such lines.

### RELATED APPLICATION

This application claims priority benefit under Title 35 U.S.C. § 119(e) of provisional application No. 61/171,808 filed on Apr. 22, 2009, which is incorporated by reference in its entirety.

### FIELD OF THE INVENTION

The present invention relates generally to repairing leaking pipe or pipe joints and, in particular, to repairing water and sewer lines.

### BACKGROUND OF THE INVENTION

Water and sewer mains periodically break due to ground shift, causing temporary flooding and water or sewer loss to customers. These breaks generally occur as a radial crack around the circumference of the main.

The breaks generally require that the mains be shut off, which requires notification of the affected customers and many precautionary measures. After turning off the water or sewer, workers dig out the break, which may require digging up an entire portion of a street, and place a repair band, or mechanical joint sleeve, around the crack. The workers may then restore pressure to the line, flush out the line to remove contamination, and finally restore each customer's water or sewer services. The process is time consuming and does not provide a permanent repair since the repair bands generally only last about six months.

Accordingly, a need exists for means to permanently or semi-permanently repair such breaks in a more efficient manner. It is the purpose of this invention to provide a means for repairing leaking joints or sections of pipe with breaks.

The present invention has many additional functions. For example, a further purpose of this invention is to provide an improved means for installing a pipe tee on lines that cannot be tapped. Another purpose of this invention is to tie new water or sewer lines to existing lines after testing. Still another purpose of this invention is to provide the ability to replace existing valves and fire hydrants without the use of mechanical sleeves and extensive excavation. Other objects, purposes and functions will become evident to those skilled in the art from the information, figures and claims provided herein.

### BRIEF SUMMARY OF THE INVENTION

The present invention is directed to a method and apparatus for permanently repairing a water or sewer line break with minimal excavation. The apparatus is an adjustable length pipe fitting which provides a watertight seal.

### BRIEF DESCRIPTION OF THE DRAWINGS

FIG. 1 illustrates a male-female configuration of the apparatus.

FIG. 2 is a side view of a male-female configuration of the apparatus.

FIG. 3 is a cross-sectional view of the male-female configuration of the apparatus.

FIG. 4 illustrates a female-female configuration of the apparatus.

FIG. 5 depicts the apparatus as placed into a broken pipe.

FIG. 6 is a cross-sectional view of the apparatus installed within a gasketed pipe.

### DETAILED DESCRIPTION OF THE INVENTION

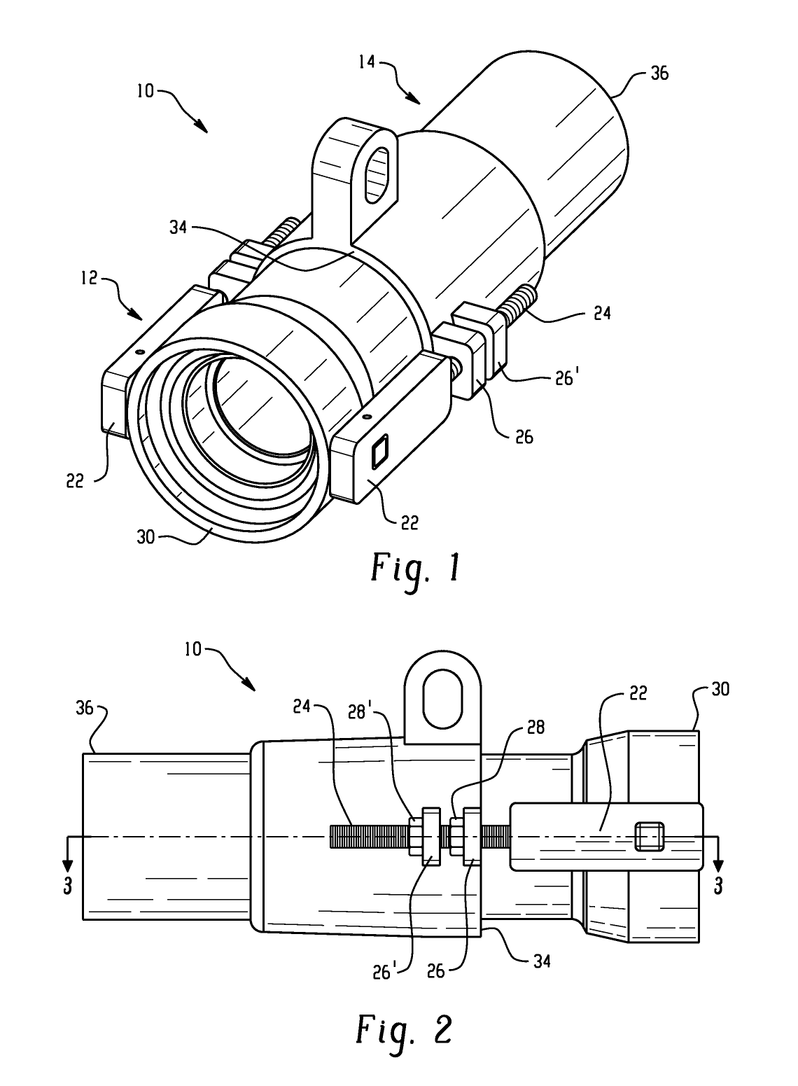

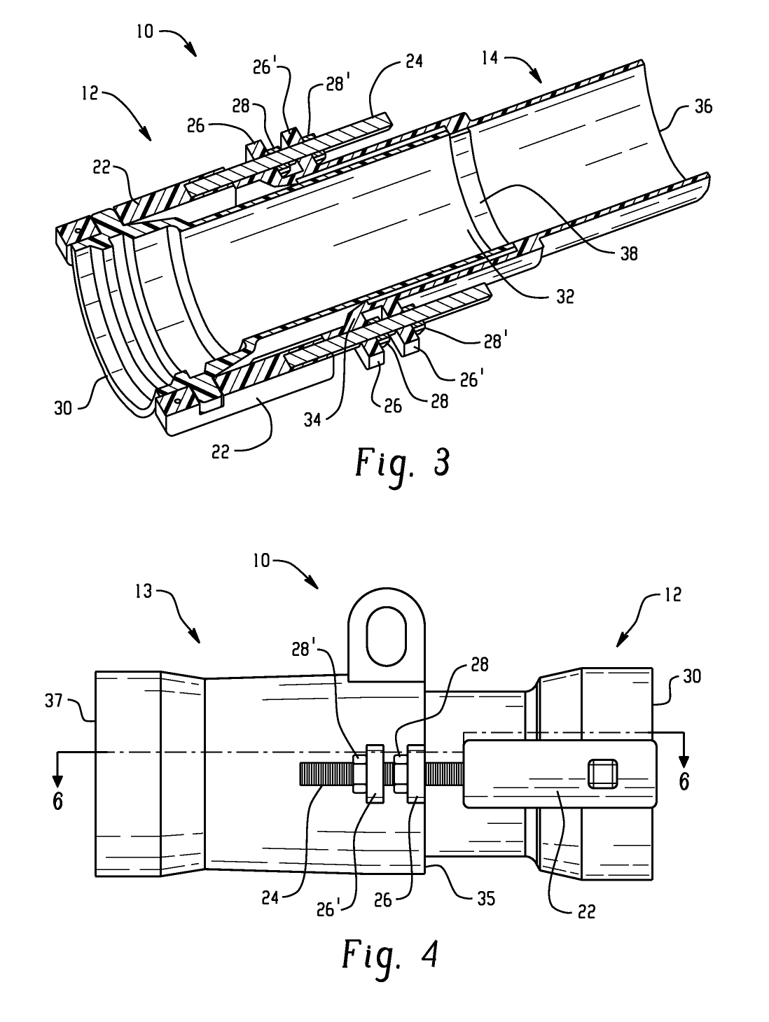

Referring initially to FIGS. 1-3, a fitting apparatus according to one embodiment of the present invention is shown generally at 10. In this embodiment, fitting apparatus 10 comprises a female fitting 12 and male fitting 14. Female fitting 12 has a bell end 30 and sliding end 32. Male fitting 14 has a receiving end 34 and connecting end 36. Bell end 30 and connecting end 36 are sized to connect to the pipes the fitting apparatus 10 is being used to repair.

The sliding end 32 of female fitting 12 is inserted into receiving end 34 with a gasket 38 between the two. The female fitting 12 and male fitting 14 are of a length such that there is some overlap when sliding end 32 is fully inserted into male fitting 14. In this embodiment, the overlap should be sufficient to allow female fitting 12 and male fitting 14 to be expanded at least one inch as compared to their completely collapsed position. The circumference of sliding end 32 is sized such that the connection of sliding end 32 with the gasket 38 in receiving end 34 creates a watertight seal but is still sufficiently loose so that female fitting 12 and male fitting 14 may slide to expand.

Male fitting 14 further comprises a pair of support rings 26, 26′ attached to each side of fitting 14 near receiving end 34. Female fitting 12 further comprises two retention brackets 22 attached to bell end 30. Each retention arm 22 holds in place a rod 24. Rod 24 is threaded and sized to fit through the openings of the support rings 26, 26′. Persons skilled in the art will understand that rod 24 may be a conventional rod, a bolt, or other connecting means suitable for performing the task herein described. When female fitting 12 and male fitting 14 are joined, each rod 24 is threaded first into support ring 26, then through a nut 28, then through the second support ring 26′, and finally through a second nut 28′. The nuts 28, 28′ on rods 24 may be tightened to support rings 26, 26′ such that they allow for the adjustment and locking of female fitting 12 and male fitting 14 in a fixed position at the desired amount of expansion.

It should be noted that female fitting 12 and male fitting 14 may be comprised of cast iron, steel, aluminum, brass, copper, asbestos, plastic, or other suitable material. It should also be noted that support rings 26, 26′ may be permanent, molded portions of receiving end 34 of male fitting 14. Likewise, retention arms 22 may be permanent, molded portions of the bell end 30 instead of separate components.

The embodiment of the fitting apparatus 10 as shown in FIGS. 1-3 is designed to repair a leak along a section of pipe where the leak is near a bell end of the pipe or the joint itself leaks. A worker must first cut and remove the leaking portion of the pipe, leaving an exposed pipe end and the pipe's bell end. Enough of the pipe must be removed so that the fully collapsed fitting apparatus 10 may be placed in the gap between the pipe end and bell end but not so much that the fitting apparatus 10 will not close the gap when fully expanded. The worker then positions fitting apparatus 10 between the pipe end and bell end such that the bell end 30 of the fitting apparatus 10 is in line with exposed pipe end and connecting end 36 of the fitting apparatus 10 is in line with the pipe's bell end.

When fitting apparatus 10 has been positioned as desired, the worker should expand the fitting apparatus 10 so that pipe end fits snugly into female fitting 12 and the male fitting 14 fits snugly into the pipe's bell end. The expansion of fitting apparatus 10 is accomplished by twisting the nuts 28, 28′ along rods 24 until the pipe end and pipe's bell end communicate with the bell end 30 of female fitting 12 and the connecting end 36 of male fitting 14 sufficient to create a watertight seal. It is recommended that a gasket be placed between the male fitting 14 and the pipe's bell end to ensure a watertight seal. Preferably, bell end 30 is fitted with interior grooves which also assist in forming a watertight seal. The fitting apparatus 10 can be locked into a fixed position by tightening the nuts 28, 28′ to the support rings 26, 26′. The pipe is then repaired for as long as the materials last.

Another embodiment of fitting apparatus 10 is depicted in FIG. 4. In this embodiment, fitting apparatus 10 comprises a female fitting 12 and a second female fitting 13. Female fitting 12 has a bell end 30 and sliding end 32 (not shown in FIG. 4). Female fitting 13 has a receiving end 35 and connecting bell end 37. Bell end 30 and connecting bell end 37 are sized to connect to the pipes the fitting apparatus 10 is being used to repair.

The sliding end 32 of female fitting 12 is inserted into receiving end 35 with a gasket 38 (not shown in FIG. 4) between the two. The female fitting 12 and female fitting 13 are of a length such that there is some overlap when end 32 is fully inserted into female fitting 13. In this embodiment, the overlap should be sufficient to allow female fitting 12 and female fitting 13 to be expanded at least one inch as compared to their completely collapsed position. The circumference of sliding end 32 is sized such that the connection of end 32 with the gasket 38 in end 35 creates a watertight seal but is still sufficiently loose so that female fitting 12 and female fitting 13 may slide to expand.

Female fitting 13 further comprises a pair of support rings 26, 26′ attached to each side of fitting 13 near receiving end 34. Female fitting 12 further comprises two retention brackets 22 attached to bell end 30. Each retention arm 22 holds in place a rod 24. Rod 24 is threaded and sized to fit through the openings of the support rings 26, 26′. When female fitting 12 and female fitting 13 are joined, each rod 24 is threaded first into support ring 26 closest to receiving end 34, then through a nut 28, then through the second support ring 26′, and finally through a second nut 28′. The nuts 28, 28′ on rods 24 may be tightened to support rings 26, 26′ such that they allow for the adjustment and locking of female fitting 12 and female fitting 13 in a fixed position at the desired amount of expansion.

It should be noted that female fitting 12 and female fitting 13 may be comprised of cast iron, steel, aluminum, brass, copper, asbestos, plastic, or other suitable material. It should also be noted that support rings 26, 26′ may be permanent, molded portions of female fitting 13. Likewise, retention arms 22 may be permanent, molded portions of the bell end 30 instead of separate components.

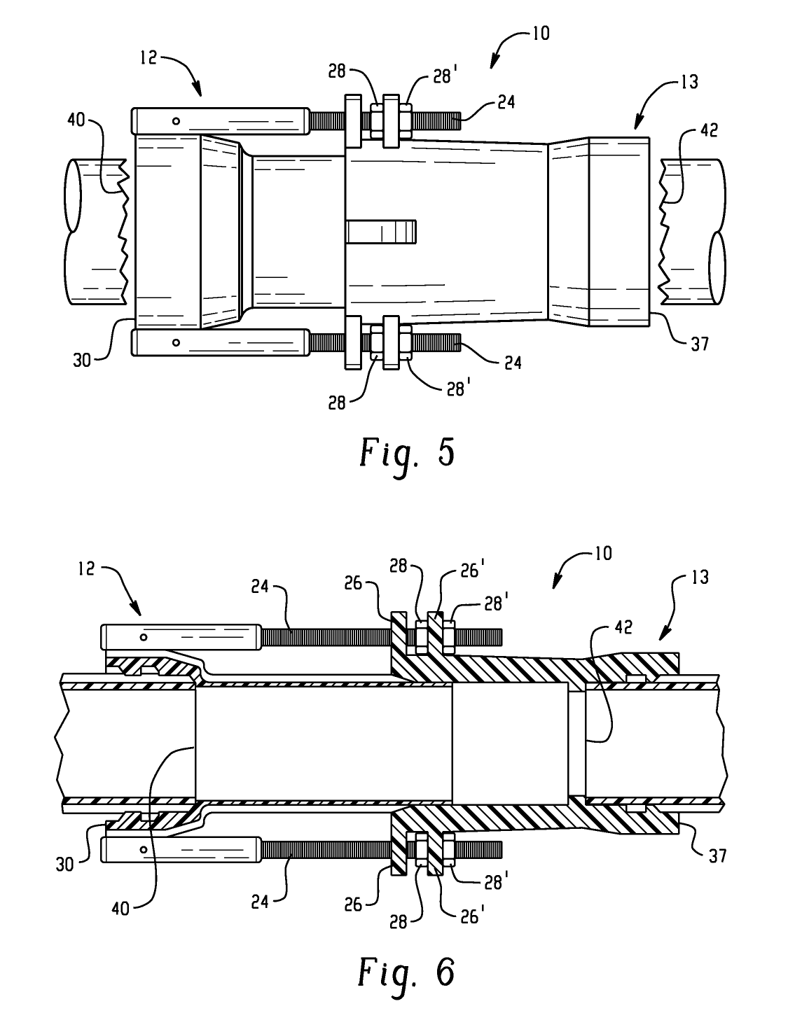

FIGS. 5 and 6 depict how a fitting apparatus 10 of the embodiment shown in FIG. 4 may be used to repair a broken pipe. A worker must first cut and remove the cracked portion of the pipe, leaving two exposed pipe ends, 40, 42. Enough of the pipe must be removed so that the fully collapsed fitting apparatus 10 may be placed in the gap between pipe ends 40, 42 but not so much that the fitting apparatus 10 will not close the gap when fully expanded. The worker then positions fitting apparatus 10 between the pipe ends 40, 42 such that bell end 30 is in line with exposed pipe end 40 and connecting bell end 37 is in line with pipe end 42.

When fitting apparatus 10 has been positioned as desired, the worker should expand the fitting apparatus 10 so that pipe end 40 fits snugly into female fitting 12 and pipe end 42 fits snugly into female fitting 13. The expansion is accomplished by twisting the nuts 28, 28′ along rods 24 until pipe ends 40, 42 communicate with the bell ends 30, 37 of female fittings 12, 13 sufficient to create a watertight seal. The fitting apparatus 10 can be locked into a fixed position by tightening the nuts 28, 28′ to the support rings 26, 26′. The pipe is then repaired for as long as the materials last.

An alternative embodiment (not shown) of fitting apparatus 10 utilizes two male fittings instead of the female-male and female-female pairings described. In any embodiment containing a male fitting, a male fitting may comprise two retention brackets used to hold in place rods to be threaded through openings of support rings attached to the other fitting.

A fitting apparatus 10 may also provide an improved means for installing a pipe tee on lines that cannot be tapped. In this embodiment, either of the fittings in a male-female, male-male, or male-female apparatus, hereinafter collectively referred to as the base fitting, may be specially constructed in a tee shape, having a tee fitting protruding therefrom.

In order to utilize this embodiment of fitting apparatus 10, a worker must first cut and remove the portion of the pipe where the tee junction is desired, leaving two exposed pipe ends. Enough of the pipe must be removed so that the fully collapsed fitting apparatus 10 may be placed in the gap between the exposed pipe ends but not so much that the fitting apparatus 10 will not close the gap when fully expanded. The worker then positions the base fitting of fitting apparatus 10 between the pipe ends and expands and tightens it as described hereinabove. A new pipe may then be connected to the available connecting end on the tee fitting, or the tee fitting may be capped off if it is not desired to immediately make use of the tee connection.

Like using a tee fitting as part of a fitting apparatus 10, other alternative embodiments (not shown) include coupling a male or female fitting with a bend fitting, corner fitting, elbow fitting, sweep fitting, wye fitting, or any other type of pipe fitting that may be necessary for the application. Additionally, in these or other embodiments, the second fitting may have any number of connections so that more than two pipes may be joined at fitting apparatus 10.

Another purpose of this invention is to tie new water or sewer lines to existing lines after testing. After a new pipeline has been tested and purified, a worker may remove the blocking and caps or plugs at the end of the new pipeline and use a fitting apparatus 10 to connect the new pipeline to existing lines. The fitting apparatus 10 used may be any of the embodiments described herein as may be appropriate to make the connection.

A fitting apparatus 10 may further be used to repair fire hydrants without having to excavate and remove poured concrete blockings. A worker must first cut and remove a section of the existing pipe connected to the hydrant's flange or valve. Enough of the pipe must be removed so that the fully collapsed fitting apparatus 10 may be placed in the gap between the exposed pipe end and the flange or valve but not so much that the fitting apparatus 10 will not close the gap when fully expanded. This allows the worker to then remove the faulty flange or valve and install a new flange or valve. The worker then may position an appropriate fitting apparatus 10 of the embodiments described herein between the pipe end and the new flange or valve.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. While numerous changes may be made by those skilled in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. An apparatus for repairing pipes, the apparatus comprising a first pipe fitting comprising two ends and a rod retainer; two rods connected to the first pipe fitting by the rod retainer; a second pipe fitting comprising at least two ends, one of which is slidably connected and forms a watertight seal with one end of said first pipe fitting, and further comprising at least two support rings on opposite sides of the second pipe fitting and sized to receive the rod; and at least two nuts threaded on the rod with a diameter sufficient to tighten the rods to the support rings; said pipe fittings of sufficient length so that there is an overlapping portion when the first fitting is fully inserted into the second fitting.

2. The apparatus of claim 1 wherein an end of the first pipe fitting comprises a female connector.

3. The apparatus of claim 1 wherein an end of the first pipe fitting comprises a male connector.

4. The apparatus of claim 1 wherein an end of the second pipe fitting comprises a female connector.

5. The apparatus of claim 1 wherein an end of the second pipe fitting comprises a male connector.

6. The apparatus of claim 1 wherein the apparatus further comprises a gasket between the two pipe fittings at the point of connection.

7. The apparatus of claim 1 wherein at least one of the fittings further comprises a fitting selected from the group consisting of tee fitting, bend fitting, corner fitting, elbow fitting, sweep fitting, and wye fitting.

8. A method for repairing a pipe, the method comprising cutting and removing a broken portion of the pipe, leaving a gap between two end sections; placing an apparatus comprising two slidably connected fittings in the gap; expanding the apparatus to fully fill the gap and re-connect the two end sections of the pipe; and fixing the slidably connected fittings in place so that the apparatus forms a watertight seal with the two end sections of the pipe.
